(19) United States
(12) Patent Application Publication
(10) Pub. No.: US 2013/0038036 A1
(43) Pub. Date: Feb. 14, 2013

(54) WHEELCHAIR STROLLER

(71) Applicant: RICHARD LESTER, Sanford, FL (US)

(72) Inventor: RICHARD LESTER, Sanford, FL (US)

(21) Appl. No.: 13/205,309

(22) Filed: Aug. 8, 2011

(51) Int. Cl. A61G 5/10

(52) U.S. Cl. 280/304.1

(57) ABSTRACT

A wheelchair stroller includes a stroller frame having a pair of opposing side members, a top cross member, and a bottom cross member, a seat, one or more handles, at least one front wheel and a pair of rear stroller legs for positioning the stroller in an upright orientation. Each of the stroller legs includes at least one connector for securing to a wheelchair.

### BACKGROUND

1. Field of the Invention

The present invention relates generally to strollers for infants and toddlers, and more particularly to a stroller adapted particularly for use in conjunction with wheelchairs or power chairs.

There are many known strollers for use by infants and toddlers. Each of these devices include a seat area positioned between one or more front wheels and a pair of rear wheels. Conventional strollers are generally designed for use by able bodied individuals capable of standing at the rear of the stroller and pushing the device in a desired direction utilizing the stroller wheels to support the weight of the child.

The present invention, directed to a wheelchair stroller differs from the foregoing art in a number of aspects. The manner by which will become more apparent in the description which follows, particularly when read in conjunction with the accompanying drawings.

### SUMMARY OF THE INVENTION

The present invention is directed to a wheelchair stroller. One embodiment of the present invention can include a stroller frame having a pair of opposing side members, a top cross member, and a bottom cross member, a seat, one or more handles, at least one front wheel and a pair of rear stroller legs for positioning the stroller in an upright orientation. Each of the stroller legs can include at least one connector for securing to a wheelchair.

Another embodiment of the present invention can include a rotatable hinge interposed between each rear stroller leg and the frame.

Another embodiment of the present invention can include each stroller leg being configured to rotate between an up position and a down position.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a wheelchair stroller that is useful for understanding the inventive concepts disclosed herein.

FIG. 1A is a cutout view of a connector in accordance with one embodiment of the invention.

FIG. 1B is a partial side view of the present invention illustrating the side frame and the rear support leg.

FIG. 2 is a perspective view of a wheelchair stroller in accordance with another embodiment of the invention.

FIG. 3 is a perspective view of the wheelchair stroller in use in accordance with one embodiment of the invention.

FIG. 4 is a side view of the wheelchair stroller in use in accordance with one embodiment of the invention.

FIG. 5 is a top view of the wheelchair stroller in use in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

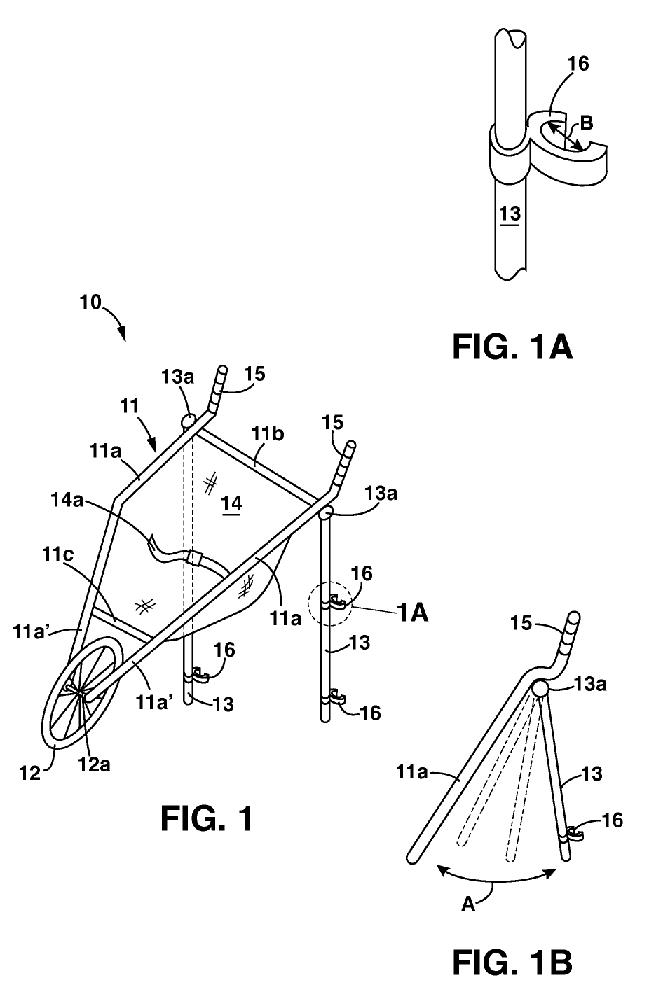

For purposes of this description, the terms “upper,” “bottom,” “right,” “left,” “front,” “vertical,” “horizontal,” and derivatives thereof shall relate to the invention as oriented in FIG. 1. Although described herein for utilization with a wheelchair, the invention is not so limited. For example, the inventive concepts disclosed herein can equally be adapted for use with any number of other devices such as, for example, powered wheelchairs (i.e. power chairs), adult mobility scooters, walkers and other such devices.

FIG. 1 illustrates one embodiment of a wheelchair stroller 10 that is useful for understanding the inventive concepts disclosed herein. In particular, the stroller 10 is adapted for use in conjunction with a traditional wheelchair in order to transport an infant or child by disabled persons. The stroller shown is a three-wheeled model but it will be apparent that the inventive features can be applied to a four wheel stroller directly or with only slight modification.

As shown, stroller 10 can include a frame 11 having a front wheel 12, a pair of rear support legs 13 a seat portion 14 and one or more handles 15 for maneuvering the stroller.

The frame 11 can act as a structure for supporting each element of the stroller, and can include opposing side members 11a, top cross member 11b, and bottom cross member 11c. As shown, each of the side members 11a can have a generally perpendicular orientation to both the top and bottom cross members 11b and 11c, respectively.

In one preferred embodiment, the frame 11 can be constructed from steel or aluminum tubing and each of the opposing side portions 11b can taper to form front forks 11a′ where the axle 12a of the front wheel is positioned. A quick release mechanism (not illustrated), as is known in the art can be provided at this connection to facilitate removal of the front wheel for storage or transport.

The rear support legs 13 can act to position the stroller in an upright position. Each rear support leg 13 can be secured to the frame 11 via a rotatable hinge 13a. In one preferred embodiment, each hinge 13a can be positioned on the frame side member 11a at a location adjacent to the top cross member 11b and configured to allow each leg 13 to pivot upward and downward (see FIG. 1A).

As described herein, the hinge 13 can include any type of known device capable of securing the support leg 13 to the frame 11 in a rotatable fashion. Additionally, it is preferred that each of the rear support legs 13 be constructed from elongated tubular steel or aluminum shafts having excellent durability and tensile strength. Although not illustrated, in one alternate embodiment, each rear support leg can be secured directly to the frame 11 in a fixed position.

In one embodiment, one or more connectors 16 can be secured to each leg 13 for allowing each stroller leg to be removably secured to a wheelchair 5. Cutout FIG. 1a illustrates one example of a connector 16, in this example a double sided C-clamp, that includes opposing circular chambers configured to expand and compress against an external object (see arrow b). Of course this is but one example of a suitable connector that can be utilized herein, as any number of conventional connection units such as compression fittings, straps, snaps, sheets of hook and loop fasteners (i.e. Velcro®), D-clips, locking pins nuts and bolts, and the like can also be utilized herein.

The seat portion 14 can preferably include a mesh/fabric material having a sleeve or guide straps located along the outside periphery for securing to each side of the frame 11 in a conventional manner. As shown, seat portion 14 can also include a seatbelt 14a.

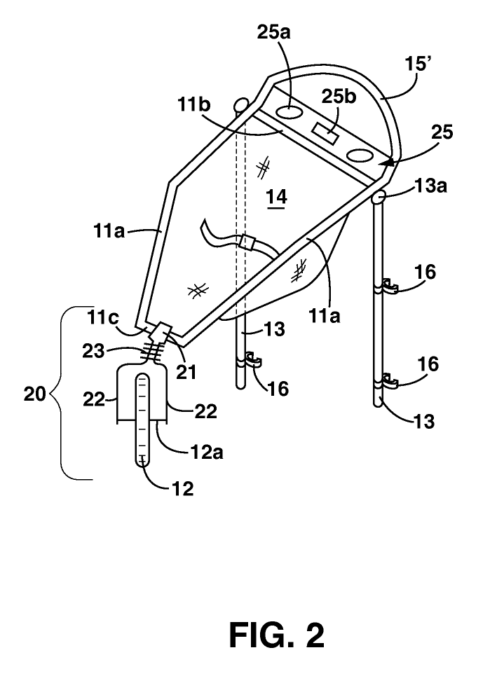

FIG. 2 illustrates an alternate embodiment of a wheelchair stroller 10 that further includes a rotatable wheel assembly 20, a large curved handle 15′ and a service tray 25.

As shown, the wheel assembly 20 can include a rotator/pivot joint 21 secured to the lower frame cross bar 11c, a pair of wheel forks 22 secured to the wheel axle 12a and a suspension/shock absorber 23 for providing a smooth ride. Stroller suspensions and pivot joints capable of allowing the wheel 13 to rotate in a 360 degree manner are extremely well known in the art, therefore no further description will be provided. Such a feature can allow the stroller 10 to more easily change direction with minimum effort by the user.

The handle 15′ can include a single curved member connected to each of the opposing frame members 11a for allowing one handed operation of the stroller.

The service tray 25 can preferably be constructed from injection molded plastic having a clip for securing to each end of the handle. As shown, the service tray can include one or more cup holders 25a and storage compartments 25b.

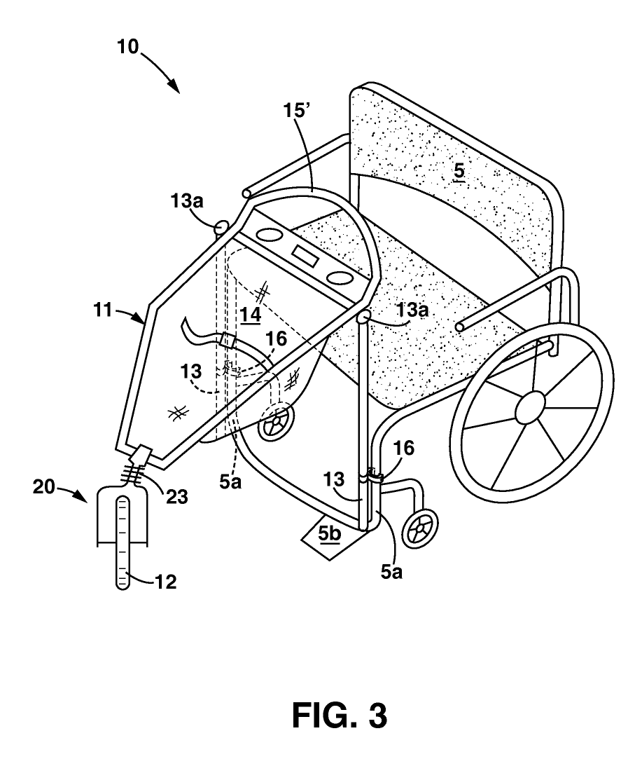

FIGS. 3-5 illustrate one embodiment of the stroller 10 in operation. As shown, each leg of the stroller 13 can be secured to a portion of the wheelchair 5 via one or more of the stroller connectors 16. As is known, a wheelchair generally consists of two or more wheels, a seat portion, and a pair of footpads 5b supported by a pair of leg frames 5a.

In one preferred embodiment, the rear legs of the stroller 13 will be secured to each of the wheelchair leg frames 5a in such a manner as to prevent the stroller legs 13 from making contact with the ground. When so attached, the stroller will become an extension of the wheelchair, and will move with the motion of the wheelchair itself, thus requiring no additional actions on the part of the wheelchair user.

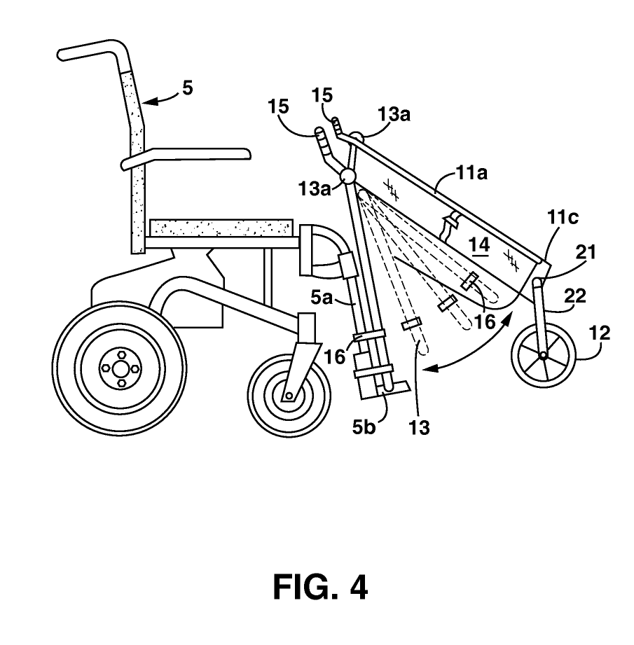

As shown in FIG. 4, the bottom end of each leg 13 can also be positioned on, or secured to the top of the wheelchair footpads 5b via one or more clips 16 in order to provide additional security in preventing the stroller legs 13 from making contact with the ground when the stroller is in use. Additionally, each stroller leg 13 can rotate from a down position to an up position via the hinge 13a (see arrow A), in order to allow a wheelchair occupant to easily ingress and egress from the wheelchair 5 without having to detach both sides of the stroller. As shown, the clip 16 can act equally to connect to the wheelchair when the stroller leg is in the down position, or can connect to the stroller frame 11a when the leg is in an up position.

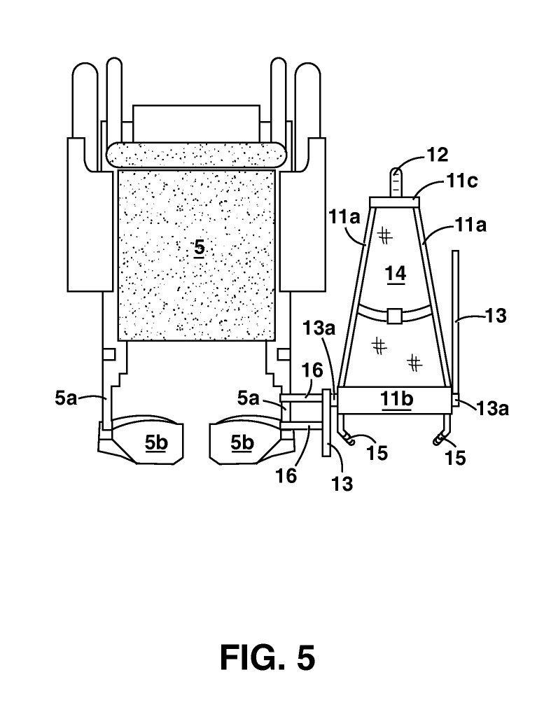

Moreover, as illustrated in FIG. 5, when only one leg 13 is secured to the wheelchair via the connector 16, the stroller can pivot 180 degrees while remaining secured to the wheelchair. Such a feature can allow the wheelchair occupant and the stroller occupant to face each other, thus increasing the interaction between the stroller and wheelchair occupants without requiring the stroller to be detached from the wheelchair itself.

As described herein, one or more elements of the wheelchair stroller 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the frame 11, the rear support legs 13, and/or the handles 15, for example, may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A wheelchair stroller comprising:
a frame that includes a pair of opposing side members, a top cross member, and a bottom cross member;
a seat disposed between each of the top, bottom and opposing side frame members;
one or more handles for grasping and moving the stroller;
at least one wheel positioned at a front end of the frame;
a pair of rear stroller legs positioned at a back end of the frame; each of said legs having a first end configured to make direct contact with the ground, and a second end connected to the frame,
wherein each of the pair of rear stroller legs are configured to position the stroller in an upright orientation; and
at least one connector secured to each of the pair of stroller legs, said connector being configured to secure each stroller leg to a wheelchair.

2. The wheelchair stroller of claim 1, further comprising:
a rotatable hinge interposed between the second end of each of the rear stroller legs and the frame.

3. The wheelchair stroller of claim 2, wherein each rotatable hinge is configured to rotate one stroller leg between an up position and a down position.

4. The wheelchair stroller of claim 3, wherein each of the stroller legs are configured to rotate independently of each other.

5. The wheelchair stroller of claim 4, wherein the stroller is configured to rotate 180 degrees about a first leg of a wheelchair to which one stroller leg is connected.

6. The wheelchair stroller of claim 4, wherein at least one of the connectors on each stroller leg is further configured to secure the stroller leg to the frame when the stroller leg is in an up position.

7. The wheelchair stroller of claim 1, wherein each of the connectors includes at least one of a compression fitting, a strap, a snap, a sheet of hook and loop fasteners, a D-clip, a double sided C-clip, and a locking pin.

8. The wheelchair stroller of claim 1, further comprising:
a quick release mechanism interposed between the wheel and the frame, said mechanism configured to allow for a quick removal of the wheel.

9. The wheelchair stroller of claim 1, further comprising:
a seatbelt configured to restrain a stroller occupant to the seat.

10. A wheelchair stroller comprising:
a frame that includes a pair of opposing side members, a top cross member, and a bottom cross member;
a seat disposed between each of the top, bottom and opposing side frame members;
one or more handles for grasping and moving the stroller;
a front wheel assembly positioned at a front end of the frame, said assembly including
a pivot joint secured to the frame,
a wheel fork supporting a wheel axle and a front wheel, and
a shock absorber,
wherein said front wheel is configured to rotate 360 degrees;
a pair of rear stroller legs positioned at a back end of the frame; each of said legs having a first end configured to make direct contact with the ground, and a second end connected to the frame,
wherein each of the pair of rear stroller legs are configured to position the stroller in an upright orientation; and
at least one connector secured to each of the pair of stroller legs, said connector being configured to secure each stroller leg to a wheelchair.

11. The wheelchair stroller of claim 10, further comprising:
a rotatable hinge interposed between the second end of each of the rear stroller legs and the frame.

12. The wheelchair stroller of claim 11, wherein each rotatable hinge is configured to rotate one stroller leg between an up position and a down position.

13. The wheelchair stroller of claim 12, wherein each of the stroller legs are configured to rotate independently of each other.

14. The wheelchair stroller of claim 13, wherein the stroller is configured to rotate 180 degrees about a first leg of a wheelchair to which one stroller leg is connected.

15. The wheelchair stroller of claim 13, wherein at least one of the connectors on each stroller leg is further configured to secure the stroller leg to the frame when the stroller leg is in an up position.

16. The wheelchair stroller of claim 10, wherein each of the connectors includes at least one of a compression fitting, a strap, a snap, a sheet of hook and loop fasteners, a D-clip, a double sided C-clip, and a locking pin.

17. The wheelchair stroller of claim 10, further comprising:
a quick release mechanism interposed between the front wheel and the wheel fork, said mechanism configured to allow for a quick removal of the wheel.

18. The wheelchair stroller of claim 10, further comprising:
a seatbelt configured to restrain a stroller occupant to the seat.

19. A wheelchair stroller comprising:
a wheelchair having a seat, a plurality of wheels, two footpads and two leg support shafts;
a stroller frame that includes a pair of opposing side members, a top cross member, and a bottom cross member;
a seat disposed between each of the top, bottom and opposing side frame members;
one or more handles for grasping and moving the stroller;
at least one wheel positioned at a front end of the frame;
a pair of rear stroller legs positioned at a back end of the frame; each of said legs having a first end configured to make direct contact with the ground, and a second end connected to the frame,
wherein each of the pair of rear stroller legs are configured to position the stroller in an upright orientation;
a rotatable hinge interposed between the second end of each rear stroller leg and the stroller frame, said rotatable hinges being configured to rotate each stroller leg between an up position and a down position; and
at least one connector interposed between each of the stroller legs and the wheelchair support shafts.

20. The wheelchair stroller of claim 19, wherein at least one of the connectors on each stroller leg is further configured to secure the stroller leg to the stroller frame when the stroller leg is in an up position.
